(19) United States
(12) Patent Application Publication
(10) Pub. No.: US 2025/0097389 A1
(43) Pub. Date: Mar. 20, 2025

(54) PROJECTION DEVICE

(71) Applicant: Qisda Corporation, Taoyuan City (TW)

(72) Inventors: Chien-Hung Lin, Taoyuan City (TW); Tzu-Huan Hsu, Taoyuan City (TW)

(73) Assignee: Qisda Corporation, Taoyuan City (TW)

(21) Appl. No.: 18/822,504

(22) Filed: Sep. 3, 2024

(30) Foreign Application Priority Data
Sep. 20, 2023 (CN) 202311217161.1

(51) Int. Cl. H04N 9/31

(52) U.S. Cl. CPC H04N 9/3144; H04N 9/3161

(57) ABSTRACT

A projection device includes a casing, a light source module, a first heat sink, a second heat sink and a fan. The casing has a first side cover and a second side cover opposite each other, the first side cover has a first opening, and the second side cover has a second opening. The light source module is configured in the casing to provide an illumination beam. The first heat sink is thermally coupled to the light source module. The second heat sink is thermally coupled to the first heat sink, and the second heat sink is closer to the first side cover than the light source module. The fan has an air outlet surface and a side surface adjacent to each other, and the first heat sink is inclined to the fan and extends to the side surface.

### CROSS-REFERENCE TO RELATED APPLICATION

This application claims the priority benefit of China application serial no. 202311217161.1, filed on Sep. 20, 2023. The entirety of the above-mentioned patent application is hereby incorporated by reference herein and made a part of this specification.

### BACKGROUND

### Technical Field

This disclosure relates to an optical device, and particularly to a projection device.

### Description of Related Art

In recent years, projectors have become thinner, lighter, and smaller, and there are more configuration restrictions to maintain system cooling in a limited space.

### SUMMARY

This disclosure provides a projection device with a good heat dissipation effect.

The projection device of this disclosure includes a casing, a light source module, a first heat sink, a second heat sink, and a fan. The casing has a first side cover and a second side cover opposite each other. The first side cover has a first opening, and the second side cover has a second opening. The light source module is configured in the casing to provide an illumination beam. The first heat sink is thermally coupled to the light source module. The second heat sink is thermally coupled to the first heat sink, and the second heat sink is closer to the first side cover than the light source module. The fan has an air outlet surface and a side surface adjacent to each other, and the first heat sink is inclined to the fan and extends to the side surface.

In an embodiment of this disclosure, the air outlet surface faces the second opening, and an ambient air outside the casing flows into the casing through the first opening. After the ambient air passes through the second heat sink and the first heat sink, the fan suctions the ambient air and blows the ambient air out of the casing through the second opening.

In an embodiment of this disclosure, the projection device includes a light valve module and a third heat sink. The light valve module is configured in the casing. The third heat sink is thermally coupled to the light valve module. The third heat sink is located between the light valve module and the second heat sink.

In an embodiment of this disclosure, the projection device further includes a heat pipe connected between the first heat sink and the second heat sink.

In an embodiment of this disclosure, the fan has an air inlet surface, and there is an air suction space between the second heat sink and the air inlet surface

In an embodiment of this disclosure, the fan further has an axial direction. In the axial direction, a gap exists between one side of the second heat sink facing the fan and the air inlet surface. The gap is between 3 mm and 5 mm.

In an embodiment of this disclosure, the casing further includes a third side cover and a fourth side cover opposite each other. The light valve module is closer to the third side cover than the second heat sink, and the side surface corresponds to the third side cover.

In an embodiment of this disclosure, the casing includes a third side cover and a fourth side cover opposite each other. The orthographic projection of the first heat sink to the fourth side cover overlaps the orthographic projection of the fan to the fourth side cover.

In an embodiment of this disclosure, a light-emitting direction of the light source module mentioned above is neither parallel nor perpendicular to the axial direction of the fan.

In an embodiment of this disclosure, the first heat sink has a first side edge and a second side edge opposite each other, and the first side edge is closer to the second heat sink than the second side edge.

In an embodiment of this disclosure, the distance between the first side edge and the second side cover is greater than the distance between the second side edge and the second side cover.

In an embodiment of this disclosure, the casing further includes a third side cover and a fourth side cover opposite each other, and the second side edge is located within the orthographic projection range of the fan to the third side cover.

In an embodiment of this disclosure, the casing further includes a third side cover and a fourth side cover opposite each other, and the first side edge is located outside the orthographic projection range of the fan to the third side cover.

In an embodiment of this disclosure, the first heat sink is located between the second heat sink and the fan.

In an embodiment of this disclosure, the light valve module is located on a transmission path of the illumination beam mentioned above to convert the illumination beam into an image beam. The projection device further includes a projection lens, which is arranged inside the casing and located on the transmission path of the image beam, and configured to project the image beam out of the projection device.

In an embodiment of this disclosure, the first heat sink is a copper plate.

In an embodiment of this disclosure, the second heat sink is a heat dissipation fin.

In an embodiment of this disclosure, the fan is an axial flow type.

In an embodiment of this disclosure, the light source module mentioned above includes a laser light source.

In an embodiment of this disclosure, the light valve module includes a Digital Micromirror Device (DMD).

Based on the above, in the projection device of this disclosure, the first heat sink and the second heat sink are located in the same space. By inclining the first heat sink to the fan and extending the first heat sink to the side surface of the fan, the first heat sink becomes an airflow retaining wall to effectively utilizing the airflow and improving the heat dissipation effect.

To make features and advantages of the disclosure more evident and easy to understand, detailed descriptive embodiments are given below with references to the accompanying drawings.

### BRIEF DESCRIPTION OF THE DRAWINGS

FIG. 1 is a schematic diagram of a projection device according to an embodiment of this disclosure.

FIG. 2 is a front view of a projection device according to an embodiment of this disclosure.

FIG. 3 is a perspective view of the projection device depicted in FIG. 2.

FIG. 4 is a schematic diagram of a projection device according to an embodiment of this disclosure.

### DETAILED DESCRIPTION OF DISCLOSED EMBODIMENTS

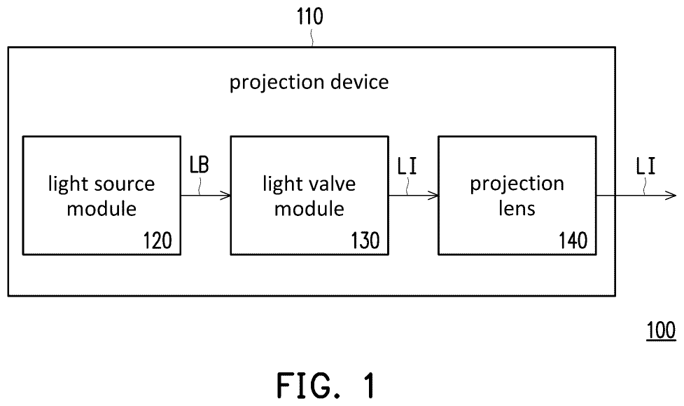

FIG. 1 is a schematic diagram of a projection device according to an embodiment of this disclosure. Please refer to FIG. 1. The projection device (projector) 100 of this embodiment includes a casing 110, a light source module 120, a light valve module 130, and a projection lens 140. The light source module 120 is configured inside the casing 110 to provide an illumination beam LB. The light valve module 130 is configured inside the casing 110 and is located on the transmission path of the illumination beam LB to convert the illumination beam LB into an image beam LI. The projection lens 140 is configured inside the casing 110, located on the transmission path of the image beam LI, and is used to project the image beam LI out of the projection device 100 to the projection target (not shown), such as a screen or a wall. This disclosure is not limited thereto. The projection device 100 here is a micro projector, but this disclosure is not limited thereto. In other embodiments, the projection device 100 may also be a commercial projector or a home projector, and this disclosure is not limited thereto.

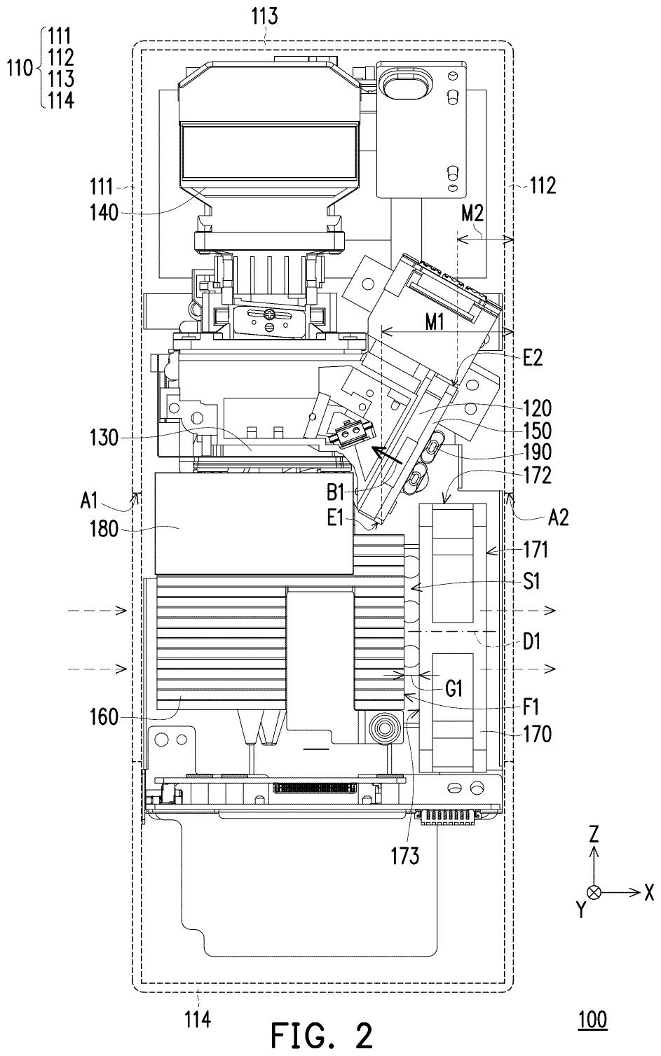

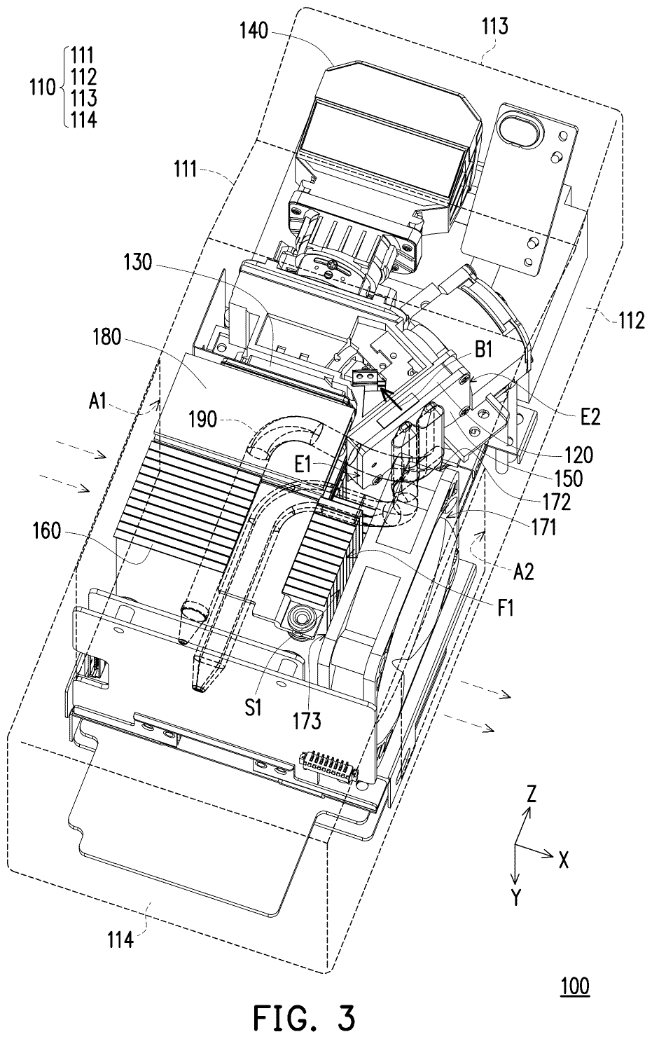

FIG. 2 is a front view of the projection device according to an embodiment of this disclosure. FIG. 3 is a perspective view of the projection device of FIG. 2. It should be noted that the X-axis, Y-axis, and Z-axis are marked in FIG. 2 and FIG. 3 to show the configuration relationship of the components in the drawings. The X-axis, Y-axis, and Z-axis intersect each other, but they are not limited thereto. Some non-relevant structures are omitted in FIG. 2 and FIG. 3 to facilitate the display and identification of the components that need to be explained.

Please refer to FIG. 2 and FIG. 3. In this embodiment, the casing 110 has a first side cover 111 and a second side cover 112 opposite each other, and a third side cover 113 and a fourth side cover 114 opposite each other. The first side cover 111 has a first opening A1, and the second side cover 112 has a second opening A2. In an embodiment, the first opening, A1, is an air inlet, and the second opening, A2, is an air outlet, but this disclosure is not limited thereto.

In this embodiment, the projection device 100 further includes a first heat sink 150, a second heat sink 160 and a fan 170. The first heat sink 150 is located between the second heat sink 160 and the fan 170. The first heat sink 150 here is a copper plate, but this disclosure is not limited thereto. The second heat sink 160 is a heat dissipation fin, but this disclosure is not limited thereto.

In this embodiment, the first heat sink 150 is thermally coupled to the light source module 120. The light source module 120 includes a laser light source, but this disclosure is not limited thereto. The second heat sink 160 is thermally coupled to the first heat sink 150, and the second heat sink 160 is closer to the first side cover 111 than the light source module 120. Specifically, the projection device 100 further includes a heat pipe 190. The heat pipe 190 is connected between the first heat sink 150 and the second heat sink 160. The second heat sink 160 is thermally coupled to the first heat sink 150 in a manner such as it is through the heat pipe 190, but this disclosure is not limited thereto.

In this embodiment, the fan 170 has an air outlet surface 171 and a side surface 172 adjacent to each other. Specifically, the air outlet surface 171 faces the second opening A2, and the side surface 172 of the fan 170 corresponds to the third side cover 113, but the disclosure is not limited thereto.

In this embodiment, the ambient air outside the casing 110 flows into the casing 110 through the first opening A1; after the ambient air passes through the second heat sink 160 and the first heat sink 150, the fan 170 suctions the ambient air and blows the ambient air out of the casing 110 through the second opening A2.

Generally speaking, in conventional projection devices, the optical engine is located below the laser light source. For microsystems, the heat dissipation fins are mostly placed under the optical engine. In other words, the optical engine will separate the laser light source from the heat dissipation fins in the Z-axis direction. Therefore, the projection device as a whole occupies a more extended space in the Z-axis direction. The projection device of this disclosure may solve the problems mentioned herein.

Please refer to FIG. 2. In this embodiment, the light source module 120 is in an inclined configuration. The first heat sink 150 is inclined towards the fan 170. In other words, the light source module 120 is located to the right of the light valve module 130, and the light source module 120 is adjacent to the second heat sink 160. Thereby, the light source module 120 and the second heat sink 160 are placed in the same space. In the Z-axis direction, the overall height of the projection device 100 may be reduced, a smaller fan 170 may be used, and the first heat sink 150 also acts as a flow channel retaining wall to use airflow effectively.

Furthermore, in this embodiment, the first heat sink 150 extends to the side surface 172 of the fan 170. Therefore, the orthographic projection of the first heat sink 150 to the fourth side cover 114 overlaps the orthographic projection of the fan 170 to the fourth side cover 114.

In this embodiment, the first heat sink 150 has a first side edge E1 and a second side edge E2 opposite each other. The first side edge E1 is closer to the second heat sink 160 than the second side edge E2. Specifically, the distance M1 between the first side edge E1 and the second side cover 112 is greater than the distance M2 between the second side edge E2 and the second side cover 112.

In this embodiment, the second side edge E2 is located within the orthographic projection range of the fan 170 to the third side cover 113, and the first side edge E1 is located outside the orthographic projection range of the fan 170 to the third side cover 113.

Specifically, in this embodiment, the fan 170 has an air inlet surface 173, and there is an air suction space S1 between the second heat sink 160 and the air inlet surface 173. The fan 170 also has an axial direction D1 (e.g. parallel to the X-axis direction). The fan 170 here is of axial flow type, but the disclosure is not limited thereto. A light-emitting direction B1 of the light source module 120 here is neither parallel nor perpendicular to the axial direction D1 of the fan 170.

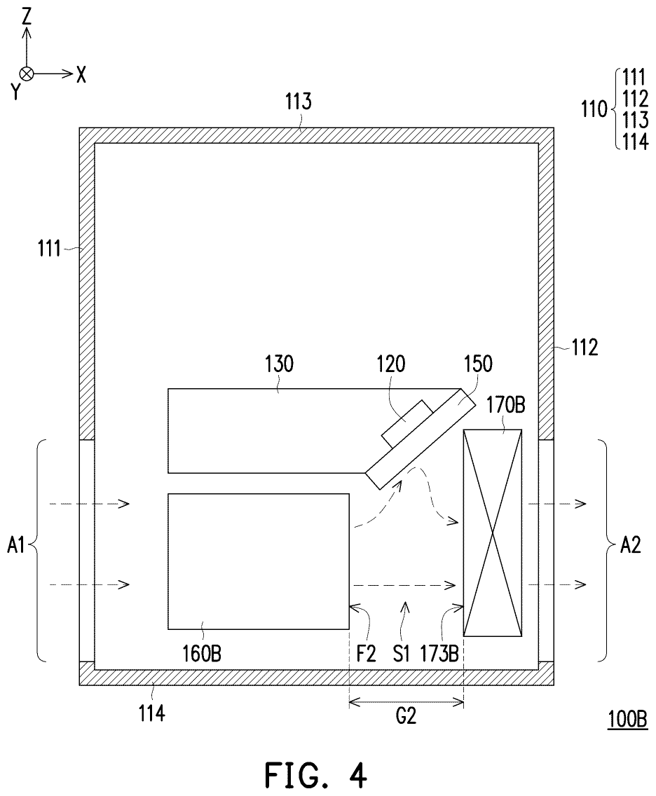

In this embodiment, in the axial direction D1, a gap G1 exists between one side F1 of the second heat sink 160 facing the fan 170 and the air inlet surface 173. The gap G1 is between 3 mm and 5 mm, but this disclosure is not limited thereto. FIG. 4 is a schematic diagram of a projection device according to an embodiment of this disclosure. It should be noted that FIG. 4 only schematically illustrates the relative positions of each component and schematically illustrates the airflow direction. Please refer to FIG. 4. In an embodiment, the orthographic projection of the first heat sink 150 of the projection device 100B to the fourth side cover 114 does not overlap with the orthographic projection of the second heat sink 160B to the fourth side cover 114. The gap G2 between one side F2 of the second heat sink 160B and the air inlet surface 173B is larger than the gap G1 in FIG. 2. However, the design of the gap may be appropriately adjusted according to actual needs, and this disclosure is not limited thereto.

In a general conventional projection device, since the optical engine separates the laser light source from the heat dissipation fins, the air that flows through the heat dissipation fins has difficulty reaching the copper plate of the heat dissipation module of the laser light source. Therefore, the copper plate of the heat dissipation module of the laser light source does not function to block and guide the airflow. However, in this embodiment, through the design of the gap G1, after the air passes through the second heat sink 160, the airflow is not directly taken away by the fan 170. Instead, the airflow is guided through the inclined first heat sink 150 so that the air that flows through the second heat sink 160 would flow to the first heat sink 150 and dispel the heat from the first heat sink 150, effectively utilizing the airflow and improving the heat dissipation effect.

In addition, please refer to FIG. 3. In this embodiment, the projection device 100 further includes a third heat sink 180. The third heat sink 180 is thermally coupled to the light valve module 130. The third heat sink 180 is located between the light valve module 130 and the second heat sink 160. The light valve module 130 is closer to the third side cover 113 than the second heat sink 160. The third heat sink 180 here is a heat dissipation fin, but this disclosure is not limited thereto. The light valve module 130 includes a Digital Micromirror Device (DMD), but this disclosure is not limited thereto.

To sum up, in the projection device of this disclosure, the light source module is inclined so that the first heat sink thermally coupled to the light source module is also inclined. By inclining the first heat sink to the fan and extending the first heat sink to the side surface of the fan, the projection device's overall height may be reduced, and a smaller fan may be used. In addition, there is a gap between the second heat sink and the fan. The gap design prevents the fan from taking away the air directly after passing through the second heat sink. The airflow is guided through the inclined first heat sink so that the airflow passing through the second heat sink flows to the first heat sink to dispel the heat, effectively utilizing the airflow and improving the heat dissipation effect.

Although this disclosure has been disclosed above through embodiments, they are not intended to limit this disclosure. Anyone with ordinary knowledge in the relevant technical field can make some changes and modifications without departing from the spirit and scope of this disclosure. Therefore, the protection scope of this disclosure shall be determined by the appended claims.

What is claimed is:

1. A projection device, comprising:
a casing having a first side cover and a second side cover opposite each other, the first side cover having a first opening, and the second side cover having a second opening;
a light source module configured in the casing to provide an illumination beam;
a first heat sink thermally coupled to the light source module;
a second heat sink thermally coupled to the first heat sink, the second heat sink being closer to the first side cover than the light source module; and
a fan having an air outlet surface and a side surface adjacent to each other, and the first heat sink being inclined to the fan and extending to the side surface.

2. The projection device as claimed in claim 1, wherein the air outlet surface faces the second opening, and an ambient air outside the casing flows into the casing through the first opening; after the ambient air passes through the second heat sink and the first heat sink, the fan suctions the ambient air and blows the ambient air out of the casing through the second opening.

3. The projection device as claimed in claim 1, further comprising a light valve module and a third heat sink, wherein the light valve module is configured in the casing, and the third heat sink is thermally coupled to the light valve module; the third heat sink is located between the light valve module and the second heat sink.

4. The projection device as claimed in claim 1, further comprising a heat pipe connected between the first heat sink and the second heat sink.

5. The projection device as claimed in claim 1, wherein the fan has an air inlet surface, and an air suction space is located between the second heat sink and the air inlet surface.

6. The projection device as claimed in claim 5, wherein the fan further has an axial direction; in the axial direction, a gap exists between one side of the second heat sink facing the fan and the air inlet surface; and the gap is between 3 mm and 5 mm.

7. The projection device as claimed in claim 3, wherein the casing further comprises a third side cover and a fourth side cover opposite each other; the light valve module is closer to the third side cover than the second heat sink; and the side surface corresponds to the third side cover.

8. The projection device as claimed in claim 1, wherein the casing further comprises a third side cover and a fourth side cover opposite each other; an orthographic projection of the first heat sink to the fourth side cover overlaps an orthographic projection of the fan to the fourth side cover.

9. The projection device as claimed in claim 1, wherein a light-emitting direction of the light source module is neither parallel nor perpendicular to an axial direction of the fan.

10. The projection device as claimed in claim 1, wherein the first heat sink has a first side edge and a second side edge opposite each other, and the first side edge is closer to the second heat sink than the second side edge.

11. The projection device as claimed in claim 10, wherein a distance between the first side edge and the second side cover is greater than a distance between the second side edge and the second side cover.

12. The projection device as claimed in claim 10, wherein the casing further comprises a third side cover and a fourth side cover opposite each other, and the second side edge is located within an orthographic projection range of the fan to the third side cover.

13. The projection device as claimed in claim 10, wherein the casing further comprises a third side cover and a fourth side cover opposite each other, and the first side edge is located outside an orthographic projection range of the fan to the third side cover.

14. The projection device as claimed in claim 1, wherein the first heat sink is located between the second heat sink and the fan.

15. The projection device as claimed in claim 3, wherein the light valve module is located on a transmission path of the illumination beam to convert the illumination beam into an image beam, the projection device further comprises a projection lens, which is disposed inside the casing and located on a transmission path of the image beam, and configured to project the image beam out of the projection device.

16. The projection device as claimed in claim 1, wherein the first heat sink is a copper plate.

17. The projection device as claimed in claim 1, wherein the second heat sink is a heat dissipation fin.

18. The projection device as claimed in claim 1, wherein the fan is an axial flow type.

19. The projection device as claimed in claim 1, wherein the light source module comprises a laser light source.

20. The projection device as claimed in claim 3, wherein the light valve module comprises a digital micromirror device (DMD).
